(19) United States
(12) Patent Application Publication
(10) Pub. No.: US 2009/0066108 A1
(43) Pub. Date: Mar. 12, 2009

(54) Windshield Support Assembly for Small Vehicles

(76) Inventors: Andre Deland, Drummondville (CA); Genevieve Therrien, St-Joachim de Courval (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/852,476

(22) Filed: Sep. 10, 2007

(51) Int. Cl. B60J 1/00

(52) U.S. Cl. 296/77.1

(57) ABSTRACT

The present invention provides a windshield support assembly for mounting onto small vehicles such as all-terrain vehicles (ATV). The support assembly is adapted to receive a windshield panel fixedly mounted to a support base which is itself equipped with generally two support brackets. These support brackets each comprises a portion which is receivable in a corresponding fastening bracket fixedly mounted to the handle bar of the vehicle. The support brackets of the windshield support assembly are lockable into the fastening brackets by generally two hand actuated locking means such as knobs or handles which are removably mountable to the fastening brackets. By a simple actuation of the locking means, the windshield and its support base can easily be installed or removed from the vehicle.

### CROSS-REFERENCE TO RELATED APPLICATIONS

The present patent application claims the benefits of priority of commonly assigned Canadian Patent Application No. 2,559,486, filed on Sep. 8, 2006, at the Canadian Intellectual Property Office.

### FIELD OF THE INVENTION

The present invention generally relates to accessories for small vehicles. More particularly, the present application relates to supports for windshields and other similar protection apparatuses for all-terrain vehicles and other similar vehicles.

### BACKGROUND OF THE INVENTION

Nowadays, there are an ever-increasing number of people which enjoy riding all-terrain vehicles and other similar off-road vehicles, either in trails specifically designed for this sport or even on totally uncharted terrain.

In order to adapt the vehicles to the increasing variety of terrain onto which they are ridden, companies have long been offering after-market accessories such as support racks, supplementary seats, trailer hitches, traction kits and so on.

Since these vehicles are generally subjected to vibration, it is important that the accessories mounted to the vehicles be relatively fixedly mounted in order to prevent accidental failure.

In the particular case of windshields, this is of utmost importance since the windshield generally protects the rider of the vehicle. However, on some occasions, it would be practical to be able to remove the windshield, at least temporarily. For example, when there are low branches partially blocking a trail or when the ATV must be stored or loaded onto a trailer for transport. Hence, on some occasions, it would be useful to remove the windshield in order to avoid damaging it.

Unfortunately, in the prior art, the only way to remove a windshield from the vehicle to which it was installed was to physically remove its support from the handle bar onto which it was generally fixedly mounted. This process was usually effected via the use of tools. Still, this process could not only be time consuming, it could can also be impossible when no tools were immediately available.

There is thus a need for a novel support system which allows easy mounting and removal of a windshield onto a small vehicle which obviates the aforementioned drawbacks.

### BRIEF DESCRIPTION OF THE DRAWINGS

The invention may be best understood by reference to the following detailed description and considered in connection with the accompanying drawings wherein:

FIG. 1 is a perspective exploded view of an embodiment of the present invention;

FIG. 2 is a perspective exploded view of a subset of the elements shown in FIG. 1 during a first step of the installation of the windshield support assembly;

FIG. 3 is a perspective exploded view of a subset of the elements shown in FIG. 1 during a second step of the installation of the windshield support assembly;

FIG. 4 is a perspective exploded view of a subset of the elements shown in FIG. 1 during a third step of the installation of the windshield support assembly;

FIG. 5 is a perspective exploded view of a subset of the elements shown in FIG. 1 during a fourth step of the installation of the windshield support assembly;

FIG. 6 is a perspective exploded view of a subset of the elements shown in FIG. 1 during a fifth step of the installation of the windshield support assembly.

### DETAILED DESCRIPTION OF THE PREFERRED EMBODIMENT

The present invention will now be described according to a preferred but by no means limitative embodiment. Consequently, the skill addressee will understand that different variants are possible and are within the scope of the claims.

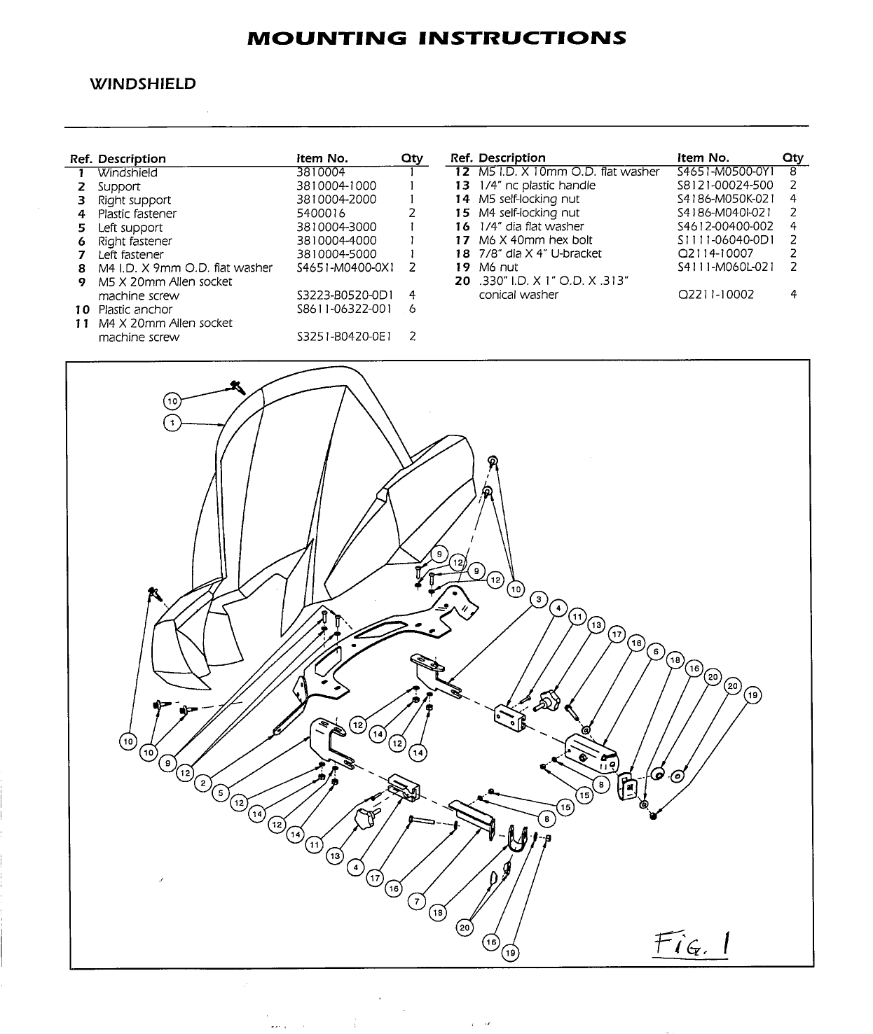

To begin with, FIG. 1 shows an exploded view of the windshield support assembly of the present invention.

Generally speaking, the windshield support assembly comprises a base support 2 to which a windshield panel 1 can be fixedly mounted with fasteners such as screws, a left support bracket 5, a right support bracket 3, a left mounting assembly comprising first fastening bracket 4, first knob or handle 13, left mounting bracket 7 and first U-shaped bracket 18 and a right mounting assembly comprising second fastening bracket 4, second knob or handle 13, right mounting bracket 7 and second U-shaped bracket 18.

During normal use, the windshield panel 1, the base support 2 and the left and right support brackets 5 and 3 form a single removable element. More particularly, the windshield panel 1 is fixedly mounted to the base support 2 with fasteners such as screws. To the base support 2 are also fixedly mounted left and right support brackets 5 and 3, also with fasteners such bolts, nuts and washers.

Still during use, the remaining components are generally fixedly mounted to the handle bar of the vehicle. More particularly, the left mounting bracket 7 and the first U-shapes bracket 18 are fixedly mounted to the left side of the handle bar with fasteners such as nuts and bolts and the right mounting bracket 6 and the second U-shapes bracket 18 are fixedly mounted to the right side of the handle bar, also with fasteners such as nuts and bolts. Moreover, the first fastening bracket 4 is fixedly mounted to the left mounting bracket 7 with fasteners such as screws and the second fastening bracket 4 is fixedly mounted to the left mounting bracket 6, also with fasteners such as screws.

At this point, with reference to FIG. 1, the skill addressee will readily understand that the present windshield support and its associated elements are of general symmetrical nature. Therefore, some elements such as knob 13 or fastening bracket 4 or U-shaped bracket 18 can be used on either the left side or the right side of the windshield support.

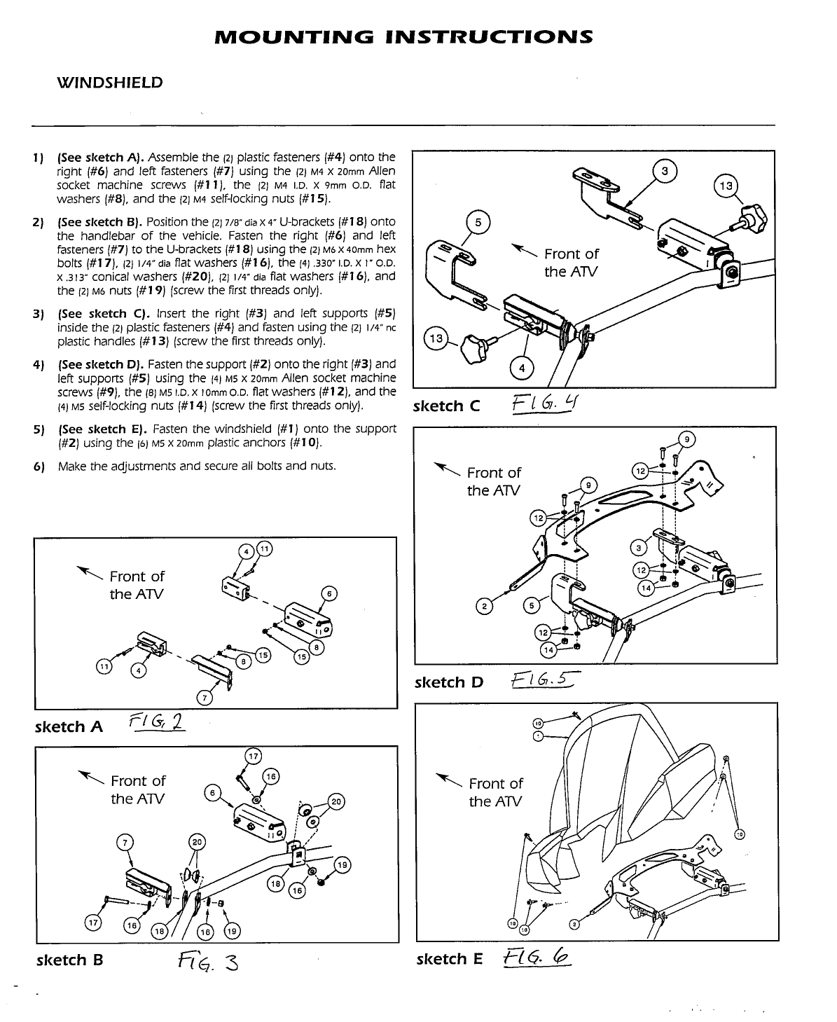

Finally, in use, the left and right support brackets 5 and 3 each comprise a protruding portion which is slid into first and second fastening brackets 4 respectively (see FIG. 4). To lock the windshield support in place, both first and second knob 13 are actuated until the support brackets 5 and 3 are solidly mounted. To remove the windshield panel 1 and understandably, its associated elements (i.e. the base support 2 and the left and right support brackets 5 and 3), the knobs 13 are actuated in reverse until the protruding portions of the support brackets 5 and 3 are free to slide out of the fastening brackets 4. The windshield panel 1 can then be pulled out from the fastening brackets 4 and removed from the vehicle.

Now referring to FIGS. 2 to 6, we can see in more details how the windshield support is actually installed onto the vehicle.

Referring now to FIG. 2, the first step is generally to mount the first and second fastening brackets 4 to mounting brackets 7 and 6 respectively. The mounting is usually effected with nuts, bolts and washer assemblies known in the art.

Referring now to FIG. 3, the second step is generally to mount the mounting brackets 7 and 6 (now with their fastening brackets 4 mounted thereon) to the first and second U-shaped brackets 18. Preferably, the curvature of the curved portion of the U-shaped brackets 18 is substantially similar to the curvature of the round portion of the handle bar. Understandably, other shapes of handle bar would imply the use of U-shaped brackets 18 having different though complementary portions.

As shown in FIG. 3, to fill in the gap between the two straight portions of each U-shaped bracket 18 and to define a substantially circular aperture through which passes the handle bar, two frustro-conical washers 20 are mounted, head to head. This particular assembly effectively fully and substantially tightly circumscribes the handle bar, thus preventing unwanted movement of the windshield support once installed.

Once the U-shaped brackets 18, the frustro-conical washers 20 and the mounting brackets 7 and 6 are mounted to the handle bar, as shown in FIG. 4, the protruding portions of the left and right support brackets 5 and 3 are slid into first and second fastening brackets 4 respectively. Once adequately slid in, the support brackets 5 and 3 are locked in place with knobs 13 which are adapted to be mounted to the mounting brackets 7 and 6.

Referring now to FIG. 5, the base support 2 is then mounted onto the left and right support brackets 5 and 3 via nuts, bolts and washer assemblies known in the art.

Finally, with reference to FIG. 6, the windshield panel 1 is mounted to the base support 2, preferably via screws.

As explained above, once fully mounted, the windshield panel 1, the base support 2 and the left and right support brackets 5 and 3 act as a single element which can, according to the present invention, easily installed or removed simply by manually actuating locking means such as the knobs 13.

From the above-recited description, the skill addressee will understand that the windshield panel 1 of the present invention is preferably transparent or at least translucent.

Although preferred embodiments of the invention have been described in detail herein and illustrated in the accompanying figures, it is to be understood that the invention is not limited to these precise embodiments and that various changes and modifications may be effected therein without departing from the scope or spirit of the present invention.

1. A windshield support assembly for a vehicle comprising a handle bar, said windshield assembly comprising:
a. a base support adapted to receive a windshield panel;
b. at least one support bracket, fixedly mountable to said base support;
c. at least one handle bar mounting bracket assembly having a first portion adapted to be fixedly mounted to said handle bar and a second portion adapted to removably receive said at least one support bracket;
d. at least one locking means, mountable to said second portion of said at least one handle bar mounting bracket assembly;
wherein said at least one locking means are adapted to secure said at least one support bracket to said second portion of said at least one handle bar mounting bracket assembly when said at least one support bracket is received in said second portion of said at least one handle bar mounting bracket assembly.

2. A windshield support assembly as claimed in claim 1, wherein said at least one locking means are hand-actuated.

3. A windshield support assembly as claimed in claim 2, wherein said at least one locking means comprise a knob portion.

4. A windshield support assembly as claimed in claim 1, wherein said at least one support bracket comprises a protruding portion.

5. A windshield support assembly as claimed in claim 4, wherein said protruding portion is configured to be received in said second portion of said at least one handle bar mounting bracket assembly.

6. A windshield support assembly as claimed in claim 4, wherein said protruding portion is configured to be slid in said second portion of said at least one handle bar mounting bracket assembly.

7. A windshield support assembly for a vehicle comprising a handle bar, said windshield assembly comprising:
a. a base support adapted to receive a windshield panel;
b. a first support bracket, fixedly mountable to said base support;
c. a second support bracket, fixedly mountable to said base support;
d. a first handle bar mounting bracket assembly having a first portion adapted to be fixedly mounted to said handle bar and a second portion adapted to receive said first support bracket;
e. a second handle bar mounting bracket assembly having a third portion adapted to be fixedly mounted to said handle bar and a fourth portion adapted to receive said second support bracket;
f. first locking means adapted to engage said first support bracket and said second portion of said first handle bar mounting bracket assembly;
g. second locking means adapted to engage said second support bracket and said fourth portion of said second handle bar mounting bracket assembly.

8. A windshield support assembly as claimed in claim 7, wherein said first support bracket comprises a first protruding portion and wherein said second support bracket comprises a second protruding portion.

9. A windshield support assembly as claimed in claim 8, wherein said first protruding portion is configured to be received in said second portion of said first handle bar mounting bracket assembly and wherein said second protruding portion is configured to be received in said fourth portion of said second handle bar mounting bracket assembly

10. A windshield support assembly as claimed in claim 8, wherein said first protruding portion is configured to be slid in said second portion of said first handle bar mounting bracket assembly and wherein said second protruding portion is configured to be slid in said fourth portion of said second handle bar mounting bracket assembly

11. A windshield support assembly for a vehicle, said windshield assembly comprising:
a. a windshield panel;
b. a support base fixedly mounted to said windshield panel;
c. a vehicle mounting assembly comprising a first portion adapted to fixedly engage said vehicle and a second portion adapted to slidingly receive said support base;
d. locking means for securing said support base to said second portion of said handle bar mounting assembly.

12. A windshield support assembly as claimed in claim 11, wherein said locking means are hand-actuated.

13. A windshield support assembly as claimed in claim 11, wherein said windshield panel and said support base are unitary.

14. A windshield support assembly as claimed in claim 11, wherein said vehicle further comprises a handlebar assembly and wherein said first portion of said vehicle mounting assembly is adapted to fixedly engage said handle bar assembly.
